(19) United States
(12) Patent Application Publication
(10) Pub. No.: US 2011/0174516 A1
(43) Pub. Date: Jul. 21, 2011

(54) DATA COMMUNICATION CABLE

(76) Inventors: Jong-Seb Baeck, Gyeongbuk (KR); Bo-Chan Jeong, Gyeongbuk (KR); Tae-Woo Kim, Gyeongbuk (KR)

(21) Appl. No.: 13/120,039

(22) PCT Filed: Sep. 25, 2009
(86) PCT No.: PCT/KR09/05496

§ 371 Date: Mar. 21, 2011

(30) Foreign Application Priority Data
Sep. 25, 2008 (KR) 10-2008-0094347

(51) Int. Cl. H01B 11/02

(52) U.S. Cl. 174/113 C

(57) ABSTRACT

Disclosed is a data communication cable, in which pair units include at least two conducting wires twisted spirally and an outer jacket surrounds the pair units, comprising an integral module of a separator for physically and electromagnetically separating the pair units from each other and a spacer for physically and electromagnetically separating the pair units from the outer jacket.

### TECHNICAL FIELD

The present invention relates to a data communication cable, and in particular, to a data communication cable capable of effectively preventing internal crosstalk and alien crosstalk caused by transmission of high frequency signals.

### BACKGROUND ART

Generally, data communication cables are used for mass data transmission of LAN (Local Area Network) or IBS (Intelligent Building System). The data communication cables are divided into Category 5, Category 6 and Category 7 cables according to their transmission characteristics. And, the data communication cables are classified into UTP (Unshielded Twisted Pair), FTP (Foiled Twisted Pair) and STP (Shielded Twisted Pair) cables according to cable shielding.

Typically, UTP cables transmit signals at a rate of about 100 Mbps. To increase the signal transmission rate up to 1 Gbps or more, frequency of about 500 MHz is required. However, when usage frequency is increased for high-rate signal transmission, attenuation or delay occurs to signals transmitted via copper due to internal pair-to-pair crosstalk. To prevent the internal pair-to-pair crosstalk, Korean Patent No. 0330921 (hereinafter referred to as Document 1) suggests a cable having a shield between pair units.

FIG. 1 is a cross-sectional view of a conventional UTP cable as in Document 1. Referring to FIG. 1, the conventional UTP cable includes four pair units 1, each of which has two insulated conducting wires 11 twisted spirally therein, a cross filler 2 for filling up the space between each pair unit 1, and an outer jacket for the pair units 1 and the cross filler 2.

Most of conventional data communication cables transmit signals under low frequency conditions. Thus, internal crosstalk does not occur, or even though internal crosstalk occurs, the internal crosstalk can be properly compensated through digital signal process (DSP).

However, while common systems for transmitting signals at gigabit rates process the signals at about 80 MHz, advanced systems for transmitting signals at a higher rate than gigabit should process the signals in the frequency range of 400 to 625 MHz so as to increase the number of transmitted signals per unit time. At this time, internal noise, i.e. internal pair-to-pair crosstalk caused by frequency expansion can be compensated by controlling how much pair units of the cables are twisted. But, it is difficult to compensate for alien crosstalk between adjacent cables through DSP.

To solve the alien crosstalk problem, STP cables or FTP cables having a shield of a metal foil inserted in a jacket are suggested. However, the STP cables or FTP cables have an increase in weight and a reduction in flexibility due to addition of the shield. And, the STP cables or FTP cables require a shield inserting process in the manufacture thereof, resulting in complicated manufacturing process and difficult process ability.

### DISCLOSURE OF INVENTION

### Technical Problem

It is an object of the present invention to solve the problems, and therefore, the present invention provides a data communication cable capable of effectively preventing alien crosstalk between adjacent cables.

### Solution to Problem

In order to achieve the object, a data communication cable according to the present invention comprises at least two pair units, each pair unit including at least two conducting wires twisted spirally, the conducting wire having an insulated core therein; a separator composed of a plurality of barriers extending radially from the center of the cable for physically and electromagnetically separating the pair units from each other; an outer jacket surrounding the pair units and the separator; and a spacer for physically and electromagnetically separating the pair units from the outer jacket, wherein the separator and the spacer are united and twisted in the longitudinal direction of the cable.

At this time, according to a first aspect of the present invention, the spacer may be composed of a plurality of wings extending circumferentially from the ends of the plurality of barriers in a clockwise or counterclockwise direction.

According to a second aspect of the present invention, the separator may include a relatively shorter barrier and a relatively longer barrier, and the spacer may be composed of a plurality of wings extending circumferentially from the ends of the relatively longer barrier in clockwise and counterclockwise directions, respectively.

According to a first or second aspect of the present invention, the pair units each may have different lay length, and the plurality of wings each may have different thickness in conformity with the different lay length.

And, according to a first aspect of the present invention, the plurality of wings each has a round portion contacted with the outer jacket, the round portion being rounded at a predetermined radius of curvature, and a flat portion contacted with the pair unit.

At this time, the flat portion may be physically contacted with the pair unit and the round portion may be physically contacted with the outer jacket. Alternatively, the flat portion may be spaced a predetermined distance away from the pair unit and the round portion may be physically contacted with the outer jacket.

And, according to a variation example of a first aspect of the present invention, the plurality of wings each is formed in the shape of flat sticks having predetermined length and thickness, and rounded only at a part contacted with the outer jacket.

At this time, the pair units may be physically contacted with the wings. Alternatively, the pair units may be spaced a predetermined distance away from the wings.

And, according to a second aspect of the present invention, the wings have a protrusion extending radially.

### Advantageous Effects of Invention

The present invention can reduce alien crosstalk between adjacent cables more effectively. And, the present invention can prevent the phenomenon that a specific pair unit is more subject to alien crosstalk than other pair units.

And, the present invention provides a stable cable structure such that a spacer is supported by pair units as well as by a separator.

Furthermore, the present invention is easy to coat with an outer jacket in the manufacture of cables and can protect the outer jacket from damage caused by an internal obstacle during coating.

### BRIEF DESCRIPTION OF DRAWINGS

FIG. 1 is a cross-sectional view of a conventional data communication cable (unshielded twisted pair; UTP).

FIG. 2 is a cross-sectional view of a data communication cable according to a first embodiment of the present invention.

FIGS. 3 and 4 are cross-sectional views of variation examples of the cable of FIG. 2.

FIG. 5 is a cross-sectional view of a data communication cable according to a second embodiment of the present invention.

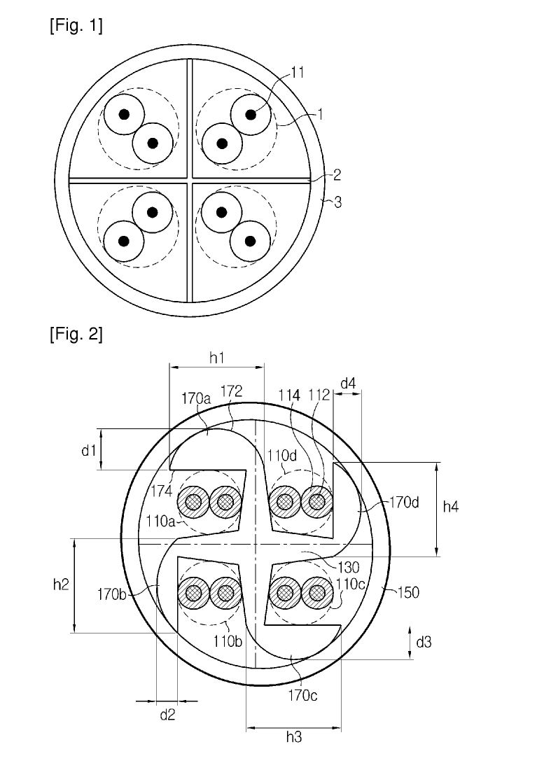

### MODE FOR THE INVENTION

Hereinafter, preferred embodiments of a data communication cable according to the present invention will be described in detail with reference to the accompanying drawings. Prior to the description, it should be understood that although the preferred embodiments of the present invention show a data communication cable with four pair units, however the present invention is not limited in this regard. Therefore, the data communication cable of the present invention may include the larger or smaller number of pair units than four pair units depending on usage environment.

### First Embodiment

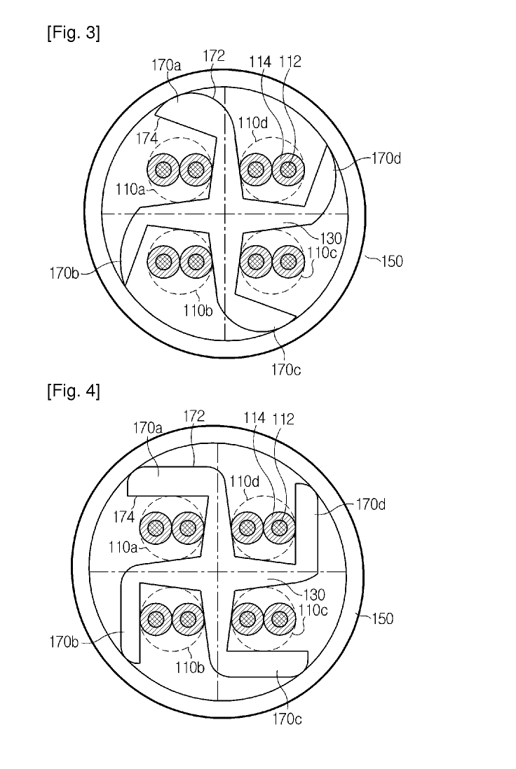

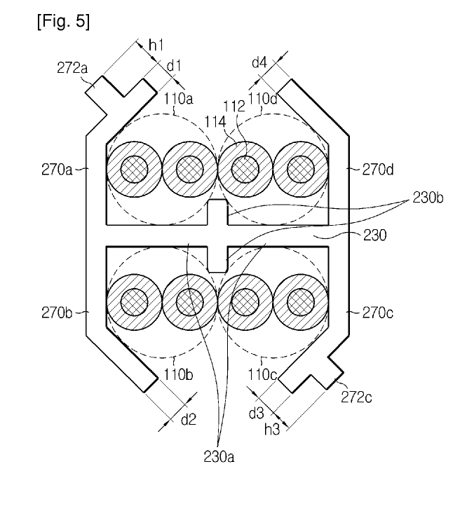

FIG. 2 is a cross-sectional view of a data communication cable according to a first embodiment of the present invention. FIGS. 3 and 4 are cross-sectional views of variation examples of the data communication cable according to the present invention.

As shown in the drawings, the data communication cable according to a first embodiment of the present invention includes four pair units 110a, 110b, 110c and 110d, a separator 130 for physically or electromagnetically separating the pair units 110a, 110b, 110c and 110d from each other, an outer jacket 150 surrounding the pair units 110a, 110b, 110c and 110d and the separator 130, and a spacer for physically or electromagnetically separating the pair units 110a, 110b, 110c and 110d from the outer jacket 150.

Each of the pair units 110a, 110b, 110c and 110d has a pair of conducting wires twisted in the longitudinal direction of the cable. Each conducting wire consists of a core 112 and an insulator 114 surrounding the core 112. At this time, if the lay length of each pair unit 110a, 110b, 110c and 110d is equal or similar, internal crosstalk between the pair units 110a, 110b, 110c and 110d may easily occur. For this reason, the pair units 110a, 110b, 110c and 110d each has different lay length.

And, the separator 130 is composed of a plurality of barriers extending radially from the center of the cable to effectively prevent the electromagnetic crosstalk between adjacent pair units, i.e. internal crosstalk. Thus, the pair units 110a, 110b, 110c and 110d are separated from each other physically as well as electromagnetically by the barriers of the separator 130.

The spacer is composed of a plurality of wings 170a, 170b, 170c and 170d. Each of the wings 170a, 170b, 170c and 170d extends circumferentially at a predetermined angle from the end of the barrier of the separator 130 in a clockwise or counter-clockwise direction. The spacer wings 170a, 170b, 170c and 170d are arranged between the pair units 110a, 110b, 110c and 110d and the outer jacket 150, respectively. Thus, each pair unit 110a, 110b, 110c and 110d is separated from the outer jacket 150 physically as well as electromagnetically by the spacer wings 170a, 170b, 170c and 170d, thereby reducing alien crosstalk between adjacent cables.

The separator 130 and the spacer are made of dielectric substances such as polyethylene (PE), polypropylene (PP) and so on, and they form an integral module. And, the separator 130 and the spacer extend in the longitudinal direction of the cable and are twisted at a predetermined pitch, like the pair units 110a, 110b, 110c and 110d.

Generally, the magnitude of alien crosstalk between adjacent cables varies depending on the lay length of the pair units 110a, 110b, 110c and 110d as a variable. The larger lay length, the larger the effects of alien crosstalk. For example, if the lay length of the pair units descends in order of 110a, 110c, 110d and 110b, the effects of alien crosstalk descends in order of 110a, 110c, 110d and 110b.

Preferably, a pair unit (for example, 110a) with the largest lay length is designed to have the longest distance from the outer jacket 150. That is, preferably the larger the lay length of the pair units 110a, 110b, 110c and 110d is, the longer the distance between each pair unit 110a, 110b, 110c and 110d and the outer jacket 150, formed by the plurality of spacer wings 170a, 170b, 170c and 170d, is designed. In this way, the effects of alien crosstalk between the plurality of pair units 110a, 110b, 110c and 110d can be equalized by controlling the distance between each pair unit 110a, 110b, 110c and 110d and the outer jacket 150 in conformity with the lay length of the pair units 110a, 110b, 110c and 110d.

The distance between the pair units 110a, 110b, 110c and 110d and the outer jacket 150 is substantially determined by the thickness d1, d2, d3 and d4 of the spacer wings 170a, 170b, 170c and 170d, respectively. That is, to equalize the effects of alien crosstalk on the pair units 110a, 110b, 110c and 110d with different lay length, the thickness d1, d2, d3 and d4 of the spacer wings 170a, 170b, 170c and 170d arranged between the pair units 110a, 110b, 110c and 110d and the outer jacket 150, respectively, are set in conformity with the lay length of the pair units 110a, 110b, 110c and 110d.

For example, the thickness d1, d2, d3 and d4 of the spacer wings 170a, 170b, 170c and 170d corresponding to the pair units 110a, 110b, 110c and 110d with lay length having a size relationship of 110a>110c>110d>110b, should have the relationship of d1>d3>d4>d2.

And, the distance between each pair unit 110a, 110b, 110c and 110d and the outer jacket 150 is influenced by the length h1, h2, h3 and h4 of the spacer wings 170a, 170b, 170c and 170d to some extent.

Preferably, each of the spacer wings 170a, 170b, 170c and 170d has one side 172 contacted with the inner periphery of the outer jacket 150, and the other side 174 contacted with the pair units 110a, 110b, 110c and 110d. In this case, the spacer wings 170a, 170b, 170c and 170d are supported by the pair units 110a, 110b, 110c and 110d as well as by the separator 130, and thus, the cable is more stable.

Meanwhile, as shown in FIG. 3, the spacer wings 170a, 170b, 170c and 170d may be spaced a predetermined distance away from the pair units 110a, 110b, 110c and 110d so that the other side 174 of the spacer wings 170a, 170b, 170c and 170d is not contacted with the pair units 110a, 110b, 110c and 110d, respectively. In this case, the cable of FIG. 3 has lower structural stability than the cable of FIG. 2, but is more advantageous to reduce and equalize the effects of alien crosstalk between adjacent cables.

As shown in FIGS. 2 and 3, the one side 172 of the spacer wings 170a, 170b, 170c and 170d may be rounded at a certain radius of curvature to form a circular arc, and the other side 174 may be flat. This makes easy it to coat with the outer jacket 150, thereby preventing the likelihood that the outer jacket 150 may be damaged by the spacer wings 170a, 170b, 170c and 170d.

And, as shown in FIG. 4, according to another variation example, each spacer wing 170a, 170b, 170c and 170d has one side 172 and the other side 174, both of which are flat, taking the shape of flat sticks, and may be rounded only at a part, in particular, contacted with the outer jacket 150. Although FIG. 4 shows all the pair units are contacted with the other side of the spacer wings, the pair units may be spaced away from the other side of the spacer wings as in FIG. 3.

### Second Embodiment

Hereinafter, a data communication cable according to another embodiment of the present invention is described with reference to FIG. 5. At this time, the same configuration as the first embodiment is omitted, and description is made based on different configurations. FIG. 5 is a cross-sectional view of a data communication cable according to a second embodiment of the present invention.

As shown in FIG. 5, the data communication cable according to this embodiment of the present invention includes four pair units 110a, 110b, 110c and 110d, a separator 230 for physically or electromagnetically separating the pair units 110a, 110b, 110c and 110d from each other, an outer jacket (not shown) surrounding the pair units 110a, 110b, 110c and 110d and the separator 230, and a spacer composed of a plurality of wings 270a, 270b, 270c and 270d for physically or electromagnetically separating the pair units 110a, 110b, 110c and 110d from the outer jacket.

The separator 130 is composed of a plurality of barriers extending radially from the center of the cable. However, the barriers of this embodiment have different length, dissimilarly from the first embodiment. For example, a barrier 230a located between the pair unit 110a and the pair unit 110b and between the pair unit 110d and the pair unit 110c is relatively longer, and a barrier 230b located between the pair unit 110a and the pair unit 110d and between the pair unit 110b and the pair unit 110c is relatively shorter. The barrier 230b located between the pair unit 110a and the pair unit 110d and between the pair unit 110b and the pair unit 110c supports the pair units 110a, 110b, 110c and 110d rather than shields internal crosstalk between the pair units 110a, 110b, 110c and 110d. That is, the separator 230 of this embodiment includes a relatively longer barrier 230a for crosstalk shielding and pair unit supporting, and a relatively shorter barrier 230b exclusively for pair unit supporting.

The plurality of spacer wings 270a, 270b, 270c and 270d extend circumferentially from both ends of the relatively longer barrier 230a in clockwise and counterclockwise directions, respectively, to space the pair units 110a, 110b, 110c and 110d at a predetermined distance away from the outer jacket. In particular, as shown in FIG. 5, each spacer wing 270a, 270b, 270c and 270d is preferably formed in the shape of “ [symbol] ”. And, the spacer wings 270a, 270b, 270c and 270d may have protrusions 272a and 272c in whole or in part. The protrusions 272a and 272c extend radially.

The distance between each pair unit 110a, 110b, 110c and 110d and the outer jacket is substantially determined by the thickness d1, d2, d3 and d4 of the spacer wings 270a, 270b, 270c and 270d, respectively. In particular, if a portion of the spacer wings 270a, 270b, 270c and 270d have the protrusions 272a and 272b, the distance between the pair units 110a, 110b, 110c and 110d and the outer jacket is determined by the thickness d1 and d3 and the length h1 and h3 of the protrusions 272a and 272b. The thickness d1, d2, d3 and d4 of the spacer wings 270a, 270b, 270c and 270d may be equal or different, or the length h1 and h3 of the protrusions 272a and 272b may be equal or different.

1. A data communication cable, comprising:
at least two pair units, each pair unit including at least two conducting wires twisted spirally, the conducting wire having an insulated core therein;
a separator composed of a plurality of barriers extending radially from the center of the cable for physically and electromagnetically separating the pair units from each other;
an outer jacket surrounding the pair units and the separator; and
a spacer for physically and electromagnetically separating the pair units from the outer jacket,
wherein the separator and the spacer are united and twisted in the longitudinal direction of the cable.

2. The data communication cable according to claim 1,
wherein the spacer is composed of a plurality of wings extending circumferentially by a predetermined length from the ends of the plurality of barriers in a clockwise or counterclockwise direction.

3. The data communication cable according to claim 2,
wherein the pair units each has different lay length, and
wherein the plurality of wings have different thickness in conformity with the different lay length.

4. The data communication cable according to claim 3,
wherein the plurality of wings each has:
a round portion contacted with the outer jacket, the round portion being rounded at a predetermined radius of curvature, and
a flat portion contacted with the pair unit.

5. The data communication cable according to claim 4,
wherein the flat portion is physically contacted with the pair unit, and the round portion is physically contacted with the outer jacket.

6. The data communication cable according to claim 4,
wherein the flat portion is spaced a predetermined distance away from the pair unit, and the round portion is physically contacted with the outer jacket.

7. The data communication cable according to claim 3,
wherein the plurality of wings each is formed in the shape of flat sticks having predetermined length and thickness, and rounded only at one part contacted with the outer jacket.

8. The data communication cable according to claim 7,
wherein the pair units are physically contacted with the wings.

9. The data communication cable according to claim 7,
wherein the pair units are spaced a predetermined distance away from the wings.

10. The data communication cable according to claim 1,
wherein the separator includes a relatively shorter barrier and a relatively longer barrier.

11. The data communication cable according to claim 10,
wherein the spacer is composed of a plurality of wings extending circumferentially from the ends of the relatively longer barrier in clockwise and counterclockwise directions, respectively.

12. The data communication cable according to claim 11,
wherein the pair units each has different lay length, and
wherein the wings each has different thickness in conformity with the different lay length.

13. The data communication cable according to claim 11,
wherein the wings have a protrusion extending radially.

14. The data communication cable according to claim 12,
wherein the wings have a protrusion extending radially.
